(19) United States
(12) Patent Application Publication
(10) Pub. No.: US 2008/0016371 A1
(43) Pub. Date: Jan. 17, 2008

(54) System and Method for Registering a Fingerprint, for Setting a Login Method of an Application, and for Logining in the Application

(75) Inventors: Yuan-Lin Jiang, Taipei (TW); Chia-Yu Wang, Taipei (TW); James K. Young, Jhonghe City (TW); Chieh-Pin Su, Taipei City (TW); Chan-Ping Po, Taipei (TW); Shin-Hsin Change, Taipei (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignees: ARACHNOID BIOMETRICS IDENTIFICATION GROUP CORP., Taipei City (TW); ACER INC., Taipei (TW)

(21) Appl. No.: 11/773,018

(22) Filed: Jul. 3, 2007

(30) Foreign Application Priority Data
Jul. 14, 2006 (TW) 95125925
Mar. 19, 2007 (TW) 96109305

(51) Int. Cl. G06K 9/00

(52) U.S. Cl. 713/186

(57) ABSTRACT

Systems and methods for registering fingerprints, setting a login method for an application, and logging into the application are provided. In the registration phase, the system receives a fingerprint signal, which is assigned to one of the many finger related data. In the phase which sets the login method, the system detects a login-signal, which comprises an identity, a password, and a command to execute the application. The system commands the display of the fingerprint related data and receives a selection message corresponding to one of the finger related data. The system assigns the application, the identity, the password to the selected fingerprint related data. In the login phase, the system receives the fingerprint signal and thereby, retrieves the corresponding application, the identity, and the password as well. The system generates a start signal comprising the identity, the password, and the command to execute the application.

This application claims the benefit of priority based on Taiwan Patent Application No. 095125925 filed on Jul. 14, 2006 and No. 096109305 filed on Mar. 19, 2007 of which the contents are incorporated herein by reference in their entirety.

### CROSS-REFERENCES TO RELATED APPLICATIONS

Not applicable.

### BACKGROUND OF THE INVENTION

1. Field of the Invention

The present invention relates to a system and a method for registering fingerprints, setting the login method of the application software, and logging into the application software. More specifically, the present invention relates to a system and a method for registering fingerprints, setting the application software whose login method is based on fingerprints, and using the fingerprints to log into the application software.

2. Descriptions of the Related Art

Biometric techniques have been developed over recent years and have been used to identify users using biometric features, such as fingerprints, faces, irises, distribution of veins, etc.

Presently, fingerprint recognition has been widely used due to its higher recognition and accuracy rates in comparison to other biometric recognitions. Techniques of fingerprint recognition detect a fingerprint of a user, capture unique fingerprint features from the fingerprint images, and then store the unique fingerprint features. After that, when the user accesses a device with his or her fingerprint, fingerprint features of the fingerprint are captured again and the re-captured fingerprint features are compared with the stored unique fingerprint features. If there is a match of the fingerprint features, the identification of the user is authorized.

Presently, various equipments use techniques of fingerprint recognition to identify a user, such as in computer logins, access controls, authentication systems, and data encryptions. A user can use these equipments only if his or her identity is authorized by the fingerprint recognition. With the rapid growth of electronic portable apparatuses, U.S. Patent Publication No. 20050085217 discloses an electronic portable apparatus with technology of fingerprint recognition, in which fingerprints of ten different fingers from the user are set to correspond to different functions of the electronic portable apparatus. For example, a user can set the thumb fingerprint to correspond to the message service. Afterward, the user can activate the message service by simply scanning the thumb fingerprint.

The conventional application of fingerprint recognition is simple. In other words, the main function of fingerprint recognition is used to identify the user only. Once the user is authenticated, the application software can be accessed as needed. However, for most complex application software, the user must remember each account and password for using the application software. Consequently, how to integrate fingerprint recognition with more complex application software that require more complex login methods is still an object for the industry to endeavor.

### SUMMARY OF THE INVENTION

One objective of this invention is to provide a system for setting a login method of an application software. The system comprises a signal detection module, a generation module, a receive module, and a setting module. The signal detection module is configured to detect a login signal which comprises an account, a password, and a command to execute the application software. The generation module is configured to generate a command signal in response to the login-signal. The command signal commands to display a plurality of pieces of fingerprint related information. The receive module is configured to receive a selection message corresponding to one of the pieces of fingerprint related information. The setting module is configured to set the application software, the account, and the password corresponding to the piece of fingerprint related information that corresponds to the selection message.

Another objective of this invention is to provide a system for logging in an application software. The system comprises a receive module, a retrieval module, and a generation module. The receive module is configured to receive a fingerprint signal. The retrieval module is configured to retrieve the application software, an account and a password related to the fingerprint signal. The generation module is configured to generate a starting signal which comprises a command that uses the account and the password to execute the application software.

Yet a further objective of this invention is to provide a fingerprint registration system adapted to a system for setting a login method of an application software. The fingerprint registration system comprises a trigger detection module, a generation module, a first receive module, a second receive module, and a setting module. The trigger detection module is configured to detect a trigger signal. The generation module is configured to generate a command signal in response to the trigger signal which commands to display a plurality of pieces of fingerprint related information. The first receive module is configured to receive a selection message corresponding to one of the pieces of fingerprint related information. The second receive module is configured to receive a fingerprint signal. The setting module is configured to set the fingerprint signal corresponding to the piece of fingerprint related information that corresponds to the selection message.

Yet a further objective of this invention is to provide a method for setting a login method of an application software. The method comprises the steps of: detecting a login-signal comprising an account, a password, and a command to execute the application software; generating a command signal in response to the login-signal, the command signal commanding to display a plurality of pieces of fingerprint related information; receiving a selection message which corresponds to a piece of fingerprint related information; and setting the application software, the account, and the password corresponding to the piece of fingerprint related information that is corresponded to the selection message.

Yet a further objective of this invention is to provide a method for logging into an application software. The method comprises the steps of: receiving a fingerprint signal; retrieving the application software, an account and a password relating to the fingerprint signal; and generating a starting signal, the starting signal comprising a command utilizing the account and the password to execute the application software.

Yet a further objective of this invention is to provide a fingerprint registration method adapted to a method for setting a login method of an application software. The fingerprint registration method comprising the steps of: detecting a trigger signal; generating a command signal in response to the trigger signal, the command signal commanding to display a plurality of pieces of fingerprint related information; receiving a selection message that corresponds to a piece of fingerprint related information; receiving a fingerprint signal; and setting the fingerprint signal corresponding to the piece of fingerprint related information that is corresponded to the selection message.

The subject of this invention is to provide a system and a method for registering fingerprints of a user, to assign the registered fingerprint to an application software, an account, and a password thereof. The user can then simply activate the application software via the fingerprint. That is, the user does not have to enter the account and the password anymore. The system and method provide a more friendly usage environment to the user who cannot remember all the accounts and passwords of various application softwares. The user may simply scan the fingerprint on the apparatus to log into the application software. Hence, this invention can eliminate the need to remember numerous accounts and passwords. The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of the first embodiment of the present invention;

FIG. 2A is a schematic diagram of a plurality of finger related information;

FIG. 2B is a schematic diagram of the finger related information;

FIG. 2C is a schematic diagram of the finger related information;

FIG. 3 is a flow chart of the second embodiment of the present invention;

FIG. 4 is a flow chart of the third embodiment of the present invention; and

FIG. 5 is a flow chart of the fourth embodiment of the present invention.

### DESCRIPTION OF THE PREFERRED EMBODIMENT

The objective of the invention is to provide a system and a method for registering a fingerprint of a user, and for assigning the registered fingerprint to an application software and a login account, and a password thereof, so that the user can activate the application software via the fingerprint. The invention can be divided into three phases: fingerprint registration, application software and fingerprint setting, and fingerprint login. The three phases can be implemented using different systems respectively or by a single system.

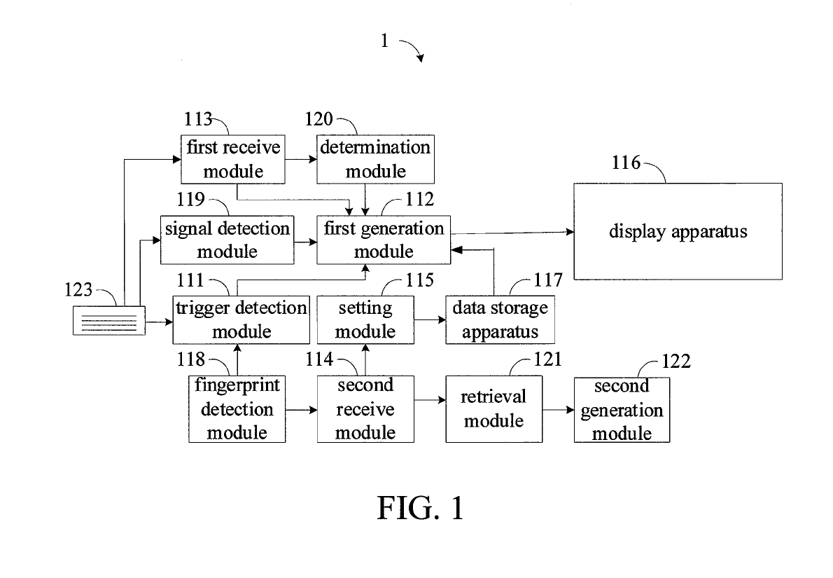

A first embodiment of the invention is shown in FIG. 1, which shows a system 1 integrating the three main phases. The system 1 comprises a trigger detection module 111, a first generation module 112, a second generation module 122, a first receive module 113, a second receive module 114, a setting module 115, a display apparatus 116, a data storage apparatus 117, a fingerprint detection module 118, a signal detection module 119, a determination module 120, a retrieval module 121, and a keyboard 123.

First, the phase of fingerprint registration of the system 1 is described. After the system 1 is started, the trigger detection module 111 is in the monitor/detection state for monitoring/detecting the presence of a trigger signal. In the first embodiment, the trigger detection module 111 detects the trigger signal from the keyboard 123, which is generated when the user presses a function key of the keyboard 123. In the other embodiments, the user can generate the trigger signal in other ways, such as pressing a hot key of the keyboard 123, pressing combination keys of the keyboard 123, clicking a mouse, or putting a finger on the fingerprint detection module 118.

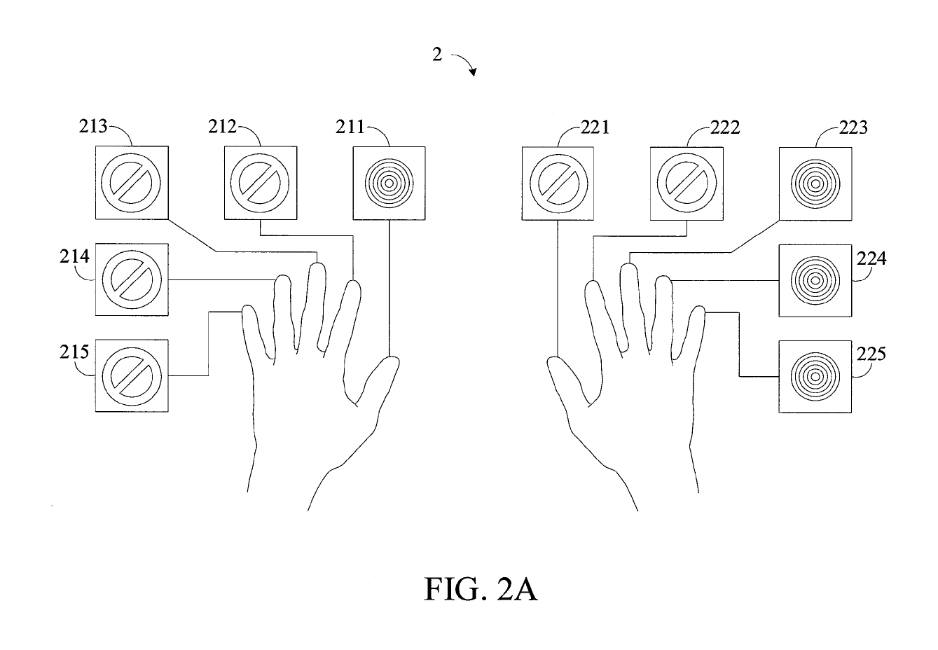

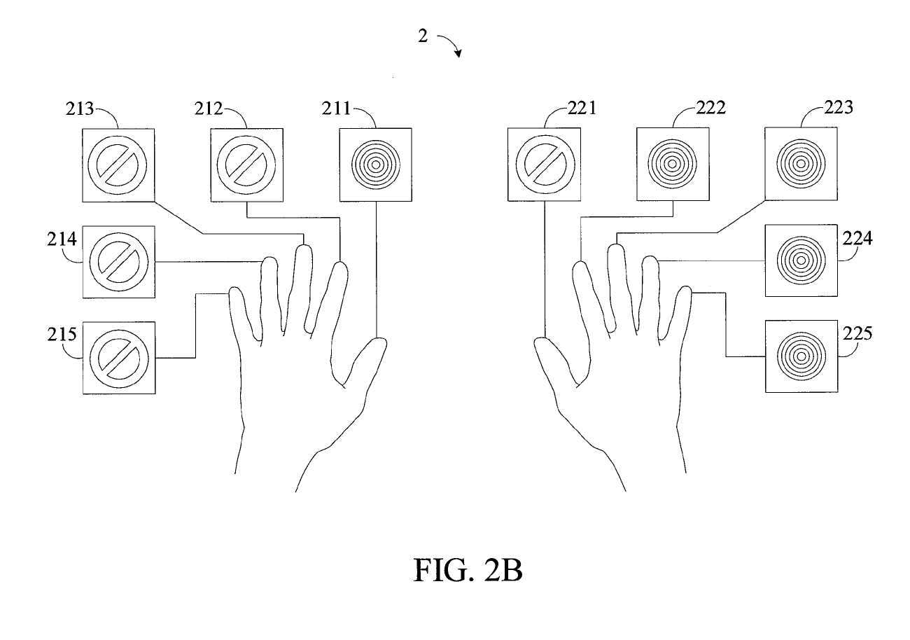

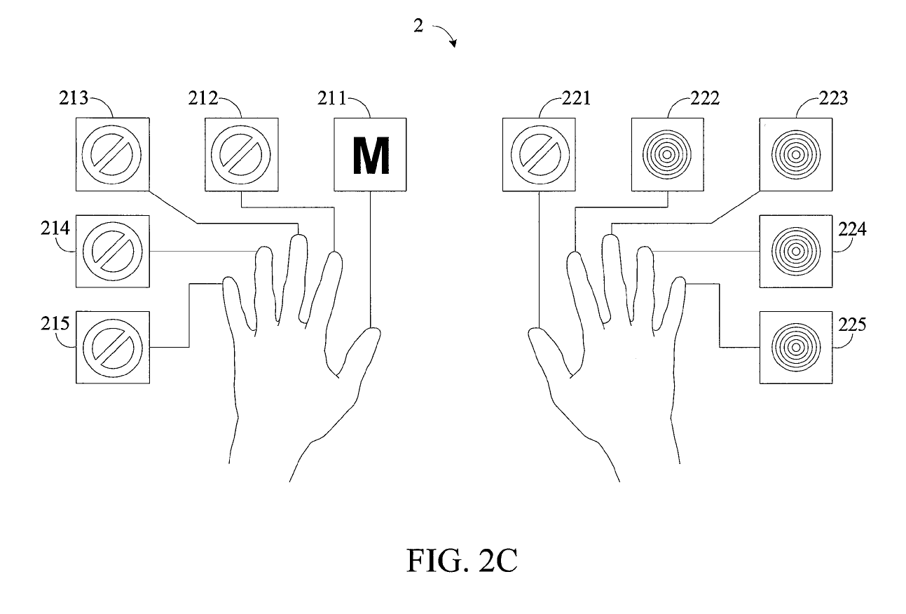

After the trigger detection module 111 detects the trigger signal, the first generation module 112 generates a first command signal, which is used to command the display apparatus 116 to display a plurality of pieces of fingerprint related information 2 shown in FIG. 2A. Specifically, the pieces of fingerprint related information 2 comprise a piece of left thumb related information 211, a piece of left forefinger related information 212, a piece of left middle finger related information 213, a piece of left ring finger related information 214, a piece of left little finger related information 215, a piece of right thumb related information 221, a piece of right forefinger related information 222, a piece of right middle finger related information 223, a piece of right ring finger related information 224, and a piece of right little finger related information 225. Each piece of finger related information may comprise a fingerprint, an application software, an account, an password, etc corresponding to the finger. As shown in FIG. 2A, the present setting of the first embodiment is that the fingerprints of the piece of left forefinger related information 212, the piece of left middle finger related information 213, the piece of left ring finger related information 214, the piece of left little finger related information 215, the piece of right thumb related information 221, and the piece of right forefinger related information 222 are not registered; the user can recognize this setting by the ban symbol inside the corresponding rectangles. At the same time, the fingerprints of the piece of right thumb related information 211, the piece of right middle finger related information 223, the piece of right ring finger related information 224, and the piece of right little finger related information 225 are registered; the user can recognize this setting by the concentric cycles inside the corresponding rectangles. It is noted that the displayed symbols are only examples and are not used to limit the scope of this invention. In other words, other ways (e.g. words, images, animations, video, etc) can also replace the ban symbol and concentric cycles inside the rectangles.

At this time, the user can select the desired piece of fingerprint related information via the keyboard 123. It is assumed that the desired piece of fingerprint related information is the piece of right forefinger related information 222. The user may also select the desired piece of fingerprint related information via other input apparatuses, such as the mouse. The first receive module 113 receives a first selection message in response to the user selection, wherein the first selection message is considered corresponding to the piece of right forefinger related information 222. At this time, the first generation module 112 generates a second command signal in response to the receiving of first selection message of the first receive module 113, wherein the second command signal commands the display apparatus 116 to show a message asking the user to input a fingerprint. After that, the user inputs the fingerprint signal of the right forefinger via the fingerprint detection module 118 and then the second receive module 114 receives the fingerprint signal of the right forefinger. Next, the setting module 115 sets the fingerprint signal of the right forefinger to correspond to the right forefinger related information 222. In response to the setting performed by the setting module 115, the display apparatus 116 displays a concentric cycle on the right forefinger related information 222 to show that the fingerprint of the right forefinger has been registered in the system 1 as shown in FIG. 2B. The data storage apparatus 117 stores the fingerprint signal of the right forefinger as well as the relationship between the fingerprint signal of right forefinger and the right forefinger related information 222.

After registering the fingerprint signal of the right forefinger, the user can either continue or discontinue registering other fingerprints. The user can build a fingerprint database via the registering fingerprints function of the system 1. The fingerprint database can be provided for the system 1 or other systems that need the fingerprint signals. The following describes how the system 1 set a login method of an application software, wherein the application software is one which requires an account and password, such as MSN, a Telnet system, or Yahoo mail service. In other words, the term of application software in this application commands softwares, application programs, system programs, Telnet systems that require a user to input an account and a password to login. As an example, MSN will be used as the application software in the following descriptions.

Similarly, after the system 1 starts, the signal detection module 119 is in the monitor/detection state for monitoring/detecting the presence of a login-signal, which comprises an account, a password, and a command to execute the application software. Specifically, when the user intends to use the application software (MSN), the user can start the application software via the input apparatus, such as a keyboard 123, input the account and the password, and then finally press the submit bottom. The signal that is generated after pressing the submit bottom is the login-signal.

After the signal detection module 119 detects the login-signal, the first generation module 112 generates the first command signal again to display the aforementioned pieces of fingerprint related information, as shown in FIG. 2B. At this time, the user can select one of the pieces of fingerprint related information (via the input apparatus) that the user would like the application software to correspond to. In response to the selection of the user, the first receive module 113 receives a second selection message. The selection of the user may result in two different ways as described next.

It is assumed that the user selects the piece of left thumb related information 211, so the second selection message received by the first receive module 113 corresponds to the left thumb related information 211. Thereafter, the setting module 115 sets the application software, the account, and the password to correspond to the piece of left thumb related information 211, which correspond to the second selection message. More specifically, the determination module 120 determines that the piece of left thumb related information 211 corresponds to the second selection message. Since the piece of left thumb related information 211 has a corresponded fingerprint signal, the setting module 115 directly sets the application software, the account, and the password to correspond to the piece of left thumb related information 211.

On the other hand, if it is assumed that the user selects the piece of left little finger related information 215, meaning that the second selection message corresponds to the left little finger related information 215. After the first receive module 113 receives the second selection message, the determination module 120 determines that the piece of left little finger related information 215 does not correspond to a fingerprint signal, meaning that the data storage apparatus 117 has not stored the fingerprint signal of the left little finger yet. At this time, the first generation module 112 generates a second command signal which displays a message that asks the user to input the fingerprint. Then, the user inputs the fingerprint of the left little finger via the fingerprint detection module 118 so that the second receive module 114 can receive the fingerprint signal of the left little finger. Next, the setting module 115 sets the fingerprint signal of the left little finger to correspond to the piece of left little finger related information 215. The setting module 115 can then set the application software, the account, and the password to correspond to the piece of left little finger related information 215, which had corresponded to the second selection message.

In the first embodiment, the user has selected the piece of left thumb related information 211. After the setting of the setting module 115, the next time the display apparatus 116 displays the pieces of fingerprint related information, the piece of left thumb related information 211 is represented by the letter “M”, as shown in FIG. 2C. This symbol represents the piece of left thumb related data and fingerprint signal corresponding to MSN as well as the corresponding account and password.

Lastly, how the system let the user login the application software, such as MSN, is described. When the user intends to use MSN, the user presses the left thumb on the fingerprint detection module 118. At this time, the second receive module 114 receives the fingerprint signal of left thumb. The retrieval module 121 retrieves the application software (MSN, in this example), the account, and the password that are related to the fingerprint signal of the left thumb. Based on the retrieved account and password, the second generation module 122 then generates a start signal which comprises a command of executing the MSN by the retrieved account and password.

According to the aforementioned descriptions, the user can pre-register the fingerprints and then set the link between the fingerprints and the different application softwares. After that, when the user intends to execute the application software, the user can just place his or her finger on the fingerprint detection module 118 instead of remembering the account and password of the application software. It is noted that the fingerprint registration, setting login method of application software, and logging in application software of the system 1 can be achieved in three different systems. This means that there are a system to register fingerprints, a system to set login method of application softwares, and a system to login application software. These three systems can cooperate with each other or be integrated with other systems for many uses.

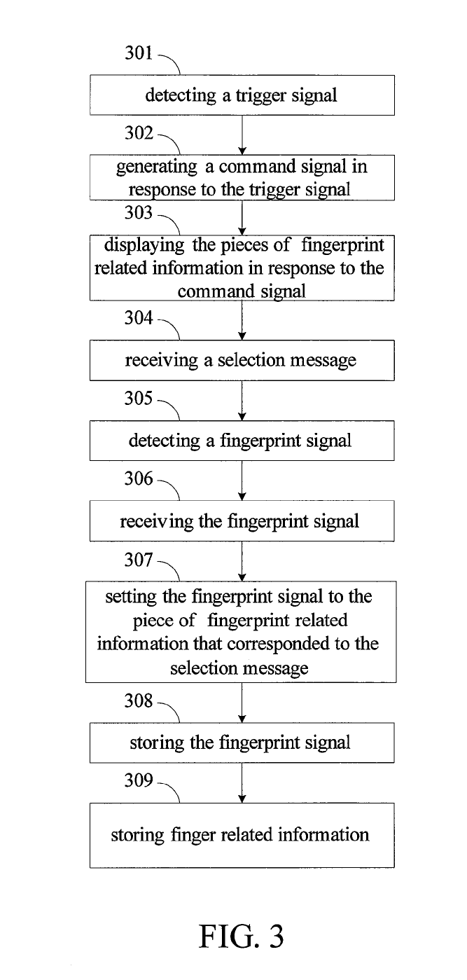

A second embodiment of the invention is shown in FIG. 3, which is a flow chart of a fingerprint registration method. The method is adapted a method for setting a login method of an application software. First, step 301 is executed to detect a trigger signal. Then, the step 302 is executed to generate a command signal in response to the trigger signal. The command signal commands to display a plurality of pieces of finger related information. Step 303 is executed to display the pieces of finger related information in response to the command signal.

After that, step 304 is executed to receive a selection message, wherein the selection message corresponds to one of the pieces of finger related information. Next, step 305 is executed to detect a fingerprint signal, and step 306 is executed to receive the fingerprint signal. Then, step 307 is executed to set the fingerprint signal to the fingerprint related information that is corresponded to the selection message. Step 308 and 309 are executed to store the fingerprint signal and stores that the fingerprint signal corresponds to the fingerprint related information, respectively.

According to the aforementioned steps, a fingerprint database may be built. In addition to the steps shown in FIG. 3, the second embodiment is able to execute all functions and operations of the fingerprint registration of the first embodiment. People skilled in this field can understand how the second embodiment executes the operations and functions of the fingerprint registration based on the first embodiment.

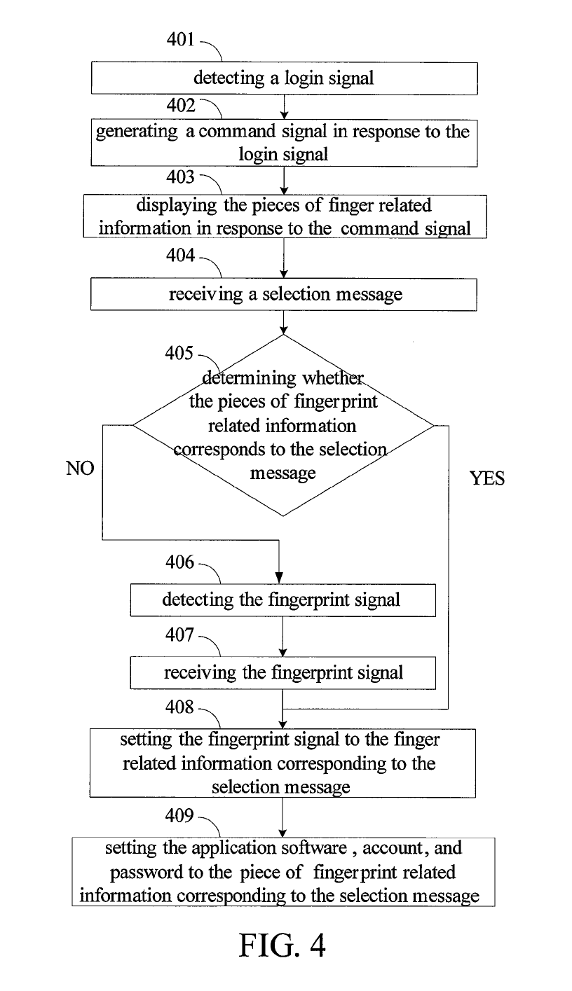

A third embodiment of the invention is shown in FIG. 4, which is a flow chart of the login method setup of the application software. First, step 401 is executed to detect a login signal comprising an account, a password, and a command to execute the application software. Then, step 402 is executed to generate a command signal, which commands to display a plurality of pieces of fingerprint related information in response to the login signal. Step 403 is executed to display the pieces of fingerprint related information in response to the command signal.

Step 404 is executed to receive a selection message, wherein the selection message corresponds to one of the pieces of finger related information. Step 405 is executed to determine whether the piece of fingerprint related information corresponding to the selection message corresponds to a fingerprint signal. If not, step 406 is executed to detect the fingerprint signal, and then step 407 is executed to receive the fingerprint signal. After that, step 408 is executed to set the fingerprint signal correspond to the piece of fingerprint related information that corresponds to the selection message. Finally, step 409 is executed to set the application software, account, and password to the piece of fingerprint related information corresponding to the selection message. If the determination result is yes in step 405, steps 406 and 407 are skipped, and steps 408 and 409 are executed.

According to the aforementioned steps, the third embodiment can build a link between the application software and the pieces of fingerprint related information. In addition to the steps shown in FIG. 4, the third embodiment is able to execute all functions and operations of setting the login method of the application software described in the first embodiment. People skilled in this field can understand how the third embodiment executes the operations and functions based on the first embodiment.

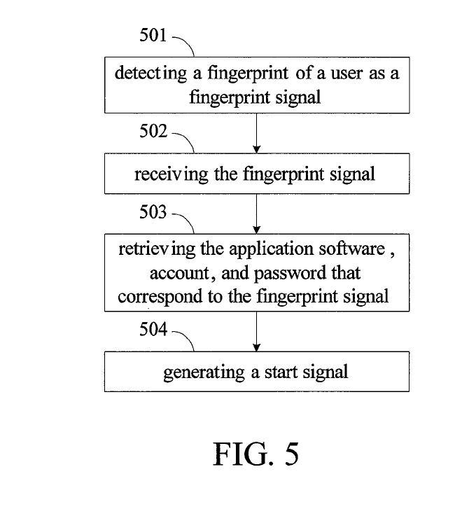

A fourth embodiment of the invention is shown in FIG. 5, which is a flow chart depicting a method for logging into the application software. First, step 501 is executed to detect a fingerprint signal of a user. Then, step 502 is executed to receive the fingerprint signal. Step 503 is executed to retrieve the application software, account, and password that correspond to the fingerprint signal. After that, step 504 is executed to generate a start signal using the retrieved account and password to execute the application software.

According to the aforementioned steps, when a user places a registered fingerprint which has a link with the application software on the equipment, the application software is automatically started by a start signal having the account and password. The user does not have to remember the account and password. In addition to the steps shown in FIG. 5, the fourth embodiment further executes all functions and operations of logging in the application software of the first embodiment. People skilled in this field can understand how the fourth embodiment executes the operations and functions based on the first embodiment.

According to the aforementioned descriptions, the user can pre-register the fingerprint via the method and system of the invention. After that, when the user intends to login into the application software, the invention detects the log-in signal and asks the user whether to link the application software and the piece of fingerprint related information is built. If so, the user can just presses the fingerprint to login into the application software and does not remember the account and password anymore. Hence, the equipment with the method and system of the invention provides a friendly environment for user.

The invention can also use a computer readable medium for storing a computer program to execute the aforementioned steps. The computer readable medium can be a floppy disk, a hard disk, an optical disc, a flash disk, a tape, a database accessible from a network or a storage medium with the same functionality that can be easily thought by people skilled in the art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A system for setting a login method of an application software, comprising:
a signal detection module for detecting a login-signal, the login-signal comprising an account, a password, and a command to execute the application software;
a generation module for generating a command signal in response to the login-signal, the command signal commanding to display a plurality of pieces of fingerprint related information;
a first receive module for receiving a selection message, the selection message corresponding to one of the pieces of fingerprint related information; and
a setting module for setting the application software, the account, and the password corresponding to the piece of fingerprint related information that is corresponded to the selection message.

2. The system of claim 1, further comprising:
a display apparatus for displaying the pieces of fingerprint related information in response to the command signal.

3. The system of claim 1, further comprising:
a determination module for determining the piece of fingerprint related information that is corresponded to the selection message corresponding to a fingerprint signal.

4. The system of claim 1, further comprising:
a determination module for determining the piece of fingerprint related information that is corresponded to the selection message not corresponding to a fingerprint signal; and
a second receive module for receiving the fingerprint signal;
wherein the setting module further sets the fingerprint signal correspond to the piece of fingerprint related information that is corresponded to the selection message.

5. The system of claim 4, further comprising:
a fingerprint detection module for detecting the fingerprint signal.

6. A system for logging in an application software, comprising:
a receive module for receiving a fingerprint signal;
a retrieval module for retrieving the application software, an account and a password relating to the fingerprint signal; and
a generation module for generating a starting signal, the starting signal comprising a command utilizing the account and the password to execute the application software.

7. The system of claim 6, further comprising:
a fingerprint detection module for detecting a fingerprint of a user to derive the fingerprint signal.

8. A fingerprint registration system, being adapted to a system for setting a login method of an application software, the fingerprint registration system comprising:
a trigger detection module for detecting a trigger signal;
a generation module for generating a command signal in response to the trigger signal, the command signal commanding to display a plurality of pieces of fingerprint related information;
a first receive module for receiving a selection message, the selection message corresponding to one of the pieces of fingerprint related information;
a second receive module for receiving a fingerprint signal; and
a setting module for setting the fingerprint signal corresponding to the piece of fingerprint related information that is corresponded to the selection message.

9. The fingerprint registration system of claim 8, further comprising:
a display apparatus for displaying the pieces of fingerprint related information in response to the command signal.

10. The fingerprint registration system of claim 8, further comprising:
a data storage apparatus for storing the fingerprint signal, the piece of fingerprint related information,
wherein the fingerprint signal corresponds to the piece of fingerprint related information that is corresponded to the selection message.

11. The fingerprint registration system of claim 8, further comprising:
a fingerprint detection module for detecting the fingerprint signal.

12. The fingerprint registration system of claim 11, wherein the trigger signal is from one of a mouse, a keyboard, and the fingerprint detection module.

13. A method for setting a login method of an application software, comprising the steps of:
detecting a login-signal, the login-signal comprising an account, a password, and a command to execute the application software;
generating a command signal in response to the login-signal, the command signal commanding to display a plurality of pieces of fingerprint related information;
receiving a selection message, the selection message corresponding to one of the pieces of fingerprint related information; and
setting the application software, the account, and the password corresponding to the piece of fingerprint related information that is corresponded to the selection message.

14. The method of claim 13, further comprising the step of:
displaying the pieces of fingerprint related information in response to the command signal.

15. The method of claim 13, further comprising the step of:
determining the piece of fingerprint related information that is corresponded to the selection message corresponding to a fingerprint signal.

16. The method of claim 13, further comprising the step of:
determining the piece of fingerprint related information that is corresponded to the selection message not corresponding to a fingerprint signal;
receiving the fingerprint signal; and
setting the fingerprint signal correspond to the piece of fingerprint related information that is corresponded to the selection message.

17. The method of claim 16, further comprising a step of detecting the fingerprint signal.

18. A method for logging in an application software, comprising the steps of:
receiving a fingerprint signal;
retrieving the application software, an account and a password relating to the fingerprint signal; and
generating a starting signal, the starting signal comprising a command utilizing the account and the password to execute the application software.

19. The method of claim 18, further comprising a step of detecting a fingerprint of a user to derive the fingerprint signal.

20. A fingerprint registration method, being adapted to a method for setting a login method of an application software, the fingerprint registration method comprising the steps of:
detecting a trigger signal;
generating a command signal in response to the trigger signal, the command signal commanding to display a plurality of pieces of fingerprint related information;
receiving a selection message, the selection message corresponding to one of the pieces of fingerprint related information;
receiving a fingerprint signal; and
setting the fingerprint signal corresponding to the piece of fingerprint related information that is corresponded to the selection message.

21. The fingerprint registration method of claim 20, further comprising the step of:
displaying the pieces of fingerprint related information in response to the command signal.

22. The fingerprint registration method of claim 20, further comprising the steps of:
storing the fingerprint signal; and
storing the fingerprint signal corresponding to the piece of fingerprint related information that is corresponded to the selection message.

23. The fingerprint registration method of claim 20, further comprising a step of detecting the fingerprint signal.

24. The fingerprint registration method of claim 23, wherein the trigger signal is from one of a mouse, a keyboard, and the fingerprint detection module.
